(19) United States
(12) Patent Application Publication
(10) Pub. No.: US 2002/0068135 A1
(43) Pub. Date: Jun. 6, 2002

(54) Structural element cover with disguised closure mechanism

(76) Inventor: James R. Fischer, Sheboygan, WI (US)

Correspondence Address: Harry C. Engstrom, FOLEY & LARDNER, P.O. Box 1497, Madison, WI, 53701-1497, US

(21) Appl. No.: 09/730,510

(22) Filed: Dec. 5, 2000

(51) Int. Cl. B32B 1/08

(52) U.S. Cl. 428/34.1; 428/58

(57) ABSTRACT

A cover for boards, posts, and other structural elements which is easily attachable to such structural elements using a closure mechanism which is disguised so as not to affect the aesthetic appearance of the cover. An outer surface of the cover includes alternating raised and recessed portions which extend along the length thereof. A closure structure is formed extending along an edge of the cover. The closure structure forms a raised portion which is of a similar size and shape to the other raised portions extending along the length of the cover. The raised portions, recessed portions, and raised closure structure extending along the length of the outer surface of the cover are formed in a relationship thereon such that, when the closure structure is employed to attach the cover to a structural element, the closure structure appears as one of many raised portions formed on the outer surface of the cover, and is thus disguised so as not to be easily visible.

### FIELD OF THE INVENTION

The present invention pertains generally to wooden structures including exposed structural elements, such as fences, deck rails, picnic tables, etc., and to construction materials used for making such structures, and, more particularly, to covers for enclosing the boards or other structural elements from which such structures are made.

### BACKGROUND OF THE INVENTION

Various structures, such as fences, deck railings, picnic tables, etc., are typically constructed using wood boards, which remain exposed when the structure is complete. Such structures are typically found out of doors, where they are continually exposed to the elements. Various methods may be employed to protect such structures from damage by the elements (e.g., precipitation, sun exposure, etc.), thereby to enhance the useful life and maintain the aesthetic appearance of such structures. For example, typically such structures may be constructed from wood boards which have been pretreated with chemicals to make the boards resistant to rot, insects, or other decay. Alternatively, or additionally, coatings may be applied to such structures to maintain the aesthetic appearance and useful life thereof. For example, the boards forming such structures may be painted, or penetrating oil stains or other water protectants may be applied thereto. These coatings may be applied to the boards before they are used to build a structure, or after a structure is complete. The process of applying such coatings to the boards, especially after a structure is complete, can be very labor-intensive and time-consuming. Additionally, such coatings typically need to be reapplied periodically, e.g., every few years, as the protective effect of the coatings is destroyed by time and the elements, and to maintain the appearance of a structure.

An alternative method of protecting and improving the appearance of a wooden structure is to enclose the boards, posts, or other structural elements from which the structure is constructed with board covers. Such covers may be formed from a plastic material using a conventional extrusion process. Plastic board covers are typically formed as elongated pieces of plastic which are shaped to cover all or a portion of the exposed surface of a wood board. Such covers may be cut to size on site, and easily mounted to the boards from which a structure is made, to protect the boards from the environment as well as to enhance the appearance of the structure. In particular, such covers may be employed quickly and effectively to improve the appearance of an old and worn structure which is too far damaged to be improved in any other way without substantial effort.

To facilitate the mounting of plastic board covers on a structure, such covers are typically formed with an openable closure mechanism formed along the length of edges of the cover. For example, such a closure mechanism may include a closure slot formed along the length of an edge of the plastic cover which is a adapted to receive and retain therein a complementary opposing edge of the cover, or a complementary edge of another complementary cover piece, to hold the edges of the piece together, or multiple pieces together, around a board, post, or other structural element. Thus, such a plastic board cover is easily mounted on an existing structure by positioning a plastic cover piece, or more than one piece, around a board and snapping opposite aligned edges of the cover or covers together using the closure mechanism to secure the cover around the board or other structural element.

One limitation of conventional plastic covers of this type is that the closure mechanism, which allows the plastic cover to be mounted easily on a board or other structural element, is typically highly visible on the surface of the cover. For example, conventional plastic board covers of this type have substantially flat, smooth outer surfaces. The portion of the closure mechanism forming the closure slot typically forms a raised portion extending along the length of the cover. This raised portion is highly visible against the otherwise flat surface of the cover. This highly visible seam can detract from the aesthetic appeal of the cover, when used on a wooden structure, especially where the cover cannot be positioned on a board such that the closure mechanism is always positioned facing away from a viewer, which is often the case with wooden structures such as decks and fences.

Therefore, what is desired is an improved cover for wooden boards, posts, and other structural elements, which is easily attachable to such structural elements to protect and improve the aesthetic appearance thereof, but which does not include a highly visible closure mechanism.

### SUMMARY OF THE INVENTION

The present invention provides an improved structural element cover for boards, posts, and other similar structural elements, which is easily attachable to such structural elements using a closure mechanism which is disguised so as not to affect adversely the aesthetic appearance of such covers. A cover in accordance with the present invention includes an elongated outer surface. The outer surface includes surface characteristics formed extending along the length thereof. For example, the outer surface of the cover may include alternating raised and recessed portions which extend along the length of the outer surface of the cover. A closure structure is formed extending along an edge of the cover. The closure structure is disguised so as to blend into the surface characteristics of the cover. For example, the closure structure may form a raised portion which extends along the length of the cover and which is of a similar size and shape to the other raised portions extending along the length of the cover. The raised portions, recessed portions, and raised closure structure extending along the length of the outer surface of the cover may be formed in a spaced relationship thereon such that, when the closure structure is employed to attach the cover to a board, post, or other structural element, the closure structure appears as one of many raised portions formed on the outer surface of the plastic cover, and is thus disguised so as not to be easily visible. Thus, the closure structure does not adversely affect the improved aesthetic appearance provided by the cover to a structure.

The closure structure may preferably be formed as a closure slot extending along an edge of the cover. The closure slot may be defined, e.g., by two facing walls, a closure structure outer wall and a closure structure inner wall, with the closure slot formed therebetween. The closure structure outer wall forming the closure slot is positioned with respect to raised portions formed along the outer surface of the cover, is sized, and is shaped, such that the outer surface of the closure structure outer wall appears similar to the other raised portions formed along the length of the outer surface of the cover, and, therefore, is disguised among the other raised portions. The closure slot thus formed is adapted to receive and retain therein a complementary (flat) edge portion of either the same cover piece or another cover piece. One or more raised ridges may be formed extending along the length of one or both interior opposed facing walls of the closure slot. These raised ridges may be formed to engage similar raised ridges formed along the length of a cover near the edge which is to be inserted into the slot. Thus, the closure slot in combination with a complementary edge to be inserted therein may form a snap closure mechanism. Preferably, the closure mechanism is easily opened and closed by hand, to facilitate mounting of a cover in accordance with the present invention on a structure, but is not easily undone by environmental elements, such as wind, to thereby ensure that the cover is securely mounted to the structure.

A cover in accordance with the present invention is preferably made of a material such as plastic, e.g., RPVC, using a conventional manufacturing technique, such as plastic extrusion forming. A cover in accordance with the present invention may, therefore, be manufactured of a plastic material in a variety of colors and include a variety of surface effects, e.g., a wood grain effect, formed on the outer surface of the cover. A cover in accordance with the present invention is preferably formed to have a cross-sectional shape and size which conforms to the boards, posts, or other structural elements with which the cover is to be employed. The cover may be formed such that the cross-sectional size and shape of the cover is selected to enclose the entire exposed surface of a board, post, or other structural element, or only a portion thereof. In the latter case, two or more cover pieces may be employed, and joined together using the closure mechanism, to cover a structural element.

A structural element cover in accordance with the present invention may be employed as part of a method for protecting and improving the appearance of an existing wooden or other structure. Either a single cover piece, or several cover pieces which are to be joined together, is selected such that the cross-sectional size and shape of the selected piece or pieces corresponds approximately to the outer cross-sectional size and shape of the board or other structural element which is to be covered. The cover piece or pieces may then be cut to the appropriate length to cover the board or other structural element, and positioned around the board or other structural element with the outer surface of the cover facing outward therefrom. The closure mechanism, formed by closure structures formed along the length of opposing edges of the cover, may then be engaged to secure the cover to the board or other structural element. Since, as discussed above, the closure mechanism is formed on the cover so as to appear, when closed, as part of the outer surface characteristics of the cover, e.g., as one of many raised portions formed extending along the length of the cover, the closure mechanism is effectively disguised, and, therefore, does not adversely affect the appearance of the cover as attached to the structure.

Further objects, features, and advantages of the invention will be apparent from the following detailed description in conjunction with the accompanying drawings.

### BRIEF DESCRIPTION OF THE DRAWINGS

In the drawings:

FIG. 1 is a perspective view of exemplary structural element covers having disguised closure mechanisms in accordance with the present invention as employed, for example, to cover boards forming portions of a deck railing.

FIG. 2 is an exploded perspective view of two structural element cover pieces in accordance with the present invention to be secured to a wooden board such that closure structures formed on the cover pieces are disguised so as not to affect adversely the aesthetic appearance thereof.

FIG. 3 is a cross-sectional view of the cover pieces in accordance with the present invention of FIG. 2, as mounted on a wooden board.

### DETAILED DESCRIPTION OF THE INVENTION

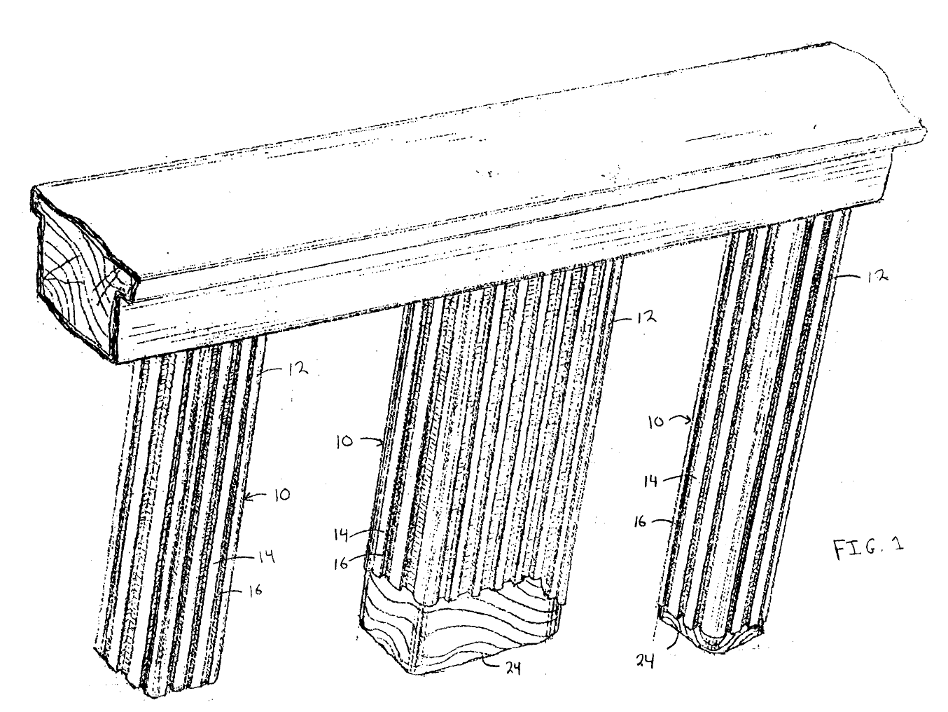

Exemplary structural element covers 10 in accordance with the present invention will be described in detail with reference to FIGS. 1-3. Although covers 10 in accordance with the present invention will be described in detail herein with reference to use of such covers for covering wooden boards and posts used to form wooden structures, such as deck railings, it should be understood that covers in accordance with the present invention may be employed to cover structural elements made of a variety of materials other than wood, which are used to form a variety of wooden or non-wooden structures. Structural element covers in accordance with the present invention may be employed to both protect the structural elements of such structures, as well as to enhance the aesthetic appearance of such structures.

A structural element cover 10 in accordance with the present invention includes an elongated outer surface 12. The outer surface 12 of the cover 10 has a surface characteristic which extends along the length of the outer surface 12 of the cover 10. For example, the outer surface 12 of a cover 10 in accordance with the present invention may have alternating raised 14 and recessed 16 portions formed extending along the length thereof. The raised 14 and recessed 16 portions formed along the length of the cover 10 give the outer surface 12 of the cover 10 a fluted or similar appearance. It should be noted that the raised 14 and recessed 16 portions formed along the length of the outer surface 12 of the cover 10 may have a different widths, spacings, and a different general appearance from those illustrated in FIGS. 1-3.

A structural element cover 10 in accordance with the present invention includes two edges 18 and 20 formed extending along the length thereof. The edges 18 and 20 may, e.g., extend parallel with the alternating raised 14 and recessed 16 portions of the surface 12 of the cover 10. A closure structure 22 is formed extending along the length of at least one edge 18 of the cover piece 10. The closure structure 22 is formed so as to blend in with the surface characteristic of the outer surface 12 of the cover 10. For example, the closure structure 22 may form a raised portion extending along the length of the cover piece 10 at the edge 18 thereof. The size and shape of the raised portion formed by the closure structure 22 may be selected so as to be similar to the size and shape of the raised portions 14 formed parallel therewith extending along the length of the outer surface 12 of the cover 10. A recessed portion 16 of the outer surface 12 of the cover piece 10 is formed adjacent to the raised portion formed by the closure structure 22. The raised portions 14, recessed portions 16, and raised portion formed by the closure structure 22, are spaced apart around the outer surface 12 of the cover piece 10 such that, when the cover piece 10 is positioned around a structural element, the outer surface 12 thereof presents an uninterrupted alternating pattern of raised and recessed portions, thereby effectively disguising the closure structure 22. In this manner, a structural element cover 10 in accordance with the present invention may be mounted on a wooden board 24, or other structural element, as will be discussed in more detail below, in a manner such that the closure structure 22 is disguised, and, therefore, does not detract from the aesthetic appearance of the cover. (See FIG. 1)

The closure structure 22 may preferably be formed as a channel or closure slot 26 formed extending along the length of at least one edge 18 of the cover piece 10. The closure structure slot 26 is preferably formed to open along the length thereof in the direction of the edge 18 of the cover piece 10. The closure slot 26 may be defined by two walls, a closure structure outer wall 28 and a closure structure inner wall 30, with the closure slot 26 formed between the outer 28 and inner 30 walls. The closure structure outer wall 28 is preferably formed to be raised from the cover piece 10 by an amount corresponding to the raised 14 portions extending along the outer surface 12 of the cover piece 10. The outer surface of the outer wall 28 is preferably also sized and shaped to conform to the size and shape of the extending portions 14 of the outer surface 12 of the cover 10. Since, when the cover piece 10 is employed to cover a wooden board or other structural element, only the outer surface of the outer wall 28 forming the closure slot 26 is visible, forming the closure structure outer wall 28 to appear similar to the extending portions 14 formed extending along the outer surface 12 of the cover piece 10 in this manner ensures that the closure structure 22 including the closure slot 26 is disguised among the extending portions 14.

The closure slot 26 is sized and shaped, and, therefore, adapted, to receive a substantially straight and flat opposing edge 20 of a structural element cover piece 10 in accordance with the present invention. The opposing edge 20 to be inserted in the closure slot 26 of one structural element cover 10 in accordance with the present invention may be on a different cover piece 10, or on the same cover piece 10, depending upon whether the cover piece 10 is designed to cover the entire surface of a structural element by itself, or in combination with other, similar, cover pieces 10. The closure slot 26, in combination with the opposing cover piece edge 20 to be positioned therein, forms a closure mechanism for closing securely a cover piece or pieces 10 around a board or other structural element. (Note that the opposing edge 20 to be inserted into the closure slot 26 may be formed to have a shape which acts in complement with the shape of the closure structure 22 forming the slot 26 to enhance the illusion that the closure mechanism formed by the edge 20 and closure structures 22, when joined together, is one of many raised portions 14 on the outer surface 12 of the cover 10.)

To ensure positive closure and engagement between the closure slot 26 and the opposing edge 20 of a cover piece 10 to be inserted therein, the closure slot 26 preferably includes one or more projections or ridges 32 formed extending from and along either or both of the inside walls thereof. These ridges 32 may preferably be formed to come to a point along the length thereof, thereby better to engage the opposing edge 20 of a cover piece 10 inserted therein, to hold the edge 20 therein more securely. The opposing edge 20 of the cover piece 10, to be inserted in a closure slot 26, may, similarly, have one or more projections or ridges 34 formed projecting therefrom and extending along the length of the cover piece 10 adjacent to the edge 20, on either or both the inside and outside surfaces of the cover piece 10. Such ridges 34 extending from the piece 10 along the length of the edge 20 engage the similar ridges 32 formed within the closure slot 26 to form a snap lock closure mechanism in which the opposing edge 20 is secured in the closure slot 26. Where the cover 20 in accordance with the present invention is made entirely of a semi-rigid material, such as plastic, such a closure mechanism allows for easy assembly and disassembly of cover pieces 10 in accordance with the present invention around structural elements, without the use of any tools, while also ensuring that the cover 10 remains in place unless intentionally removed.

Structural element cover pieces 10 in accordance with the present invention preferably may be made of a plastic material, such as polyvinylchloride (RPVC), using a conventional plastic extrusion process. In this manner, cover pieces 10 in accordance with the present invention may be manufactured easily in a variety of colors (e.g., white, gray, sand, beige, almond, etc.), with the alternating raised 14 and recessed 16 portions of the outer surface 12 of the cover 10 having a variety of configurations and designs, and with a variety of textural effects (e.g., smooth, wood grain effect, etc.) formed on the outer surface 12 thereof. Of course, it should be understood that a structural element cover 10 in accordance with the present invention may be made of any appropriate material using any appropriate manufacturing process therefore.

Structural element covers 10 in accordance with the present invention may be formed in any convenient length and cross-sectional size or shape. Preferably, cover pieces 10 in accordance with the present invention may be formed to have cross-sectional sizes and shapes which correspond to the outer circumferential surface shape of boards commonly used for building structures such as decks, fences, picnic tables, etc. For example, board covers 10 in accordance with the present invention may be formed with cross-section sizes and shapes appropriate for covering the outer circumferential surface of standard 2×2, 2×4, 4×4, etc., boards, round posts, etc. Of course, a structural element cover 10 in accordance with the present invention may be formed to have a size and shape which may be used for covering all or part of a variety of different and irregular structural element shapes and sizes.

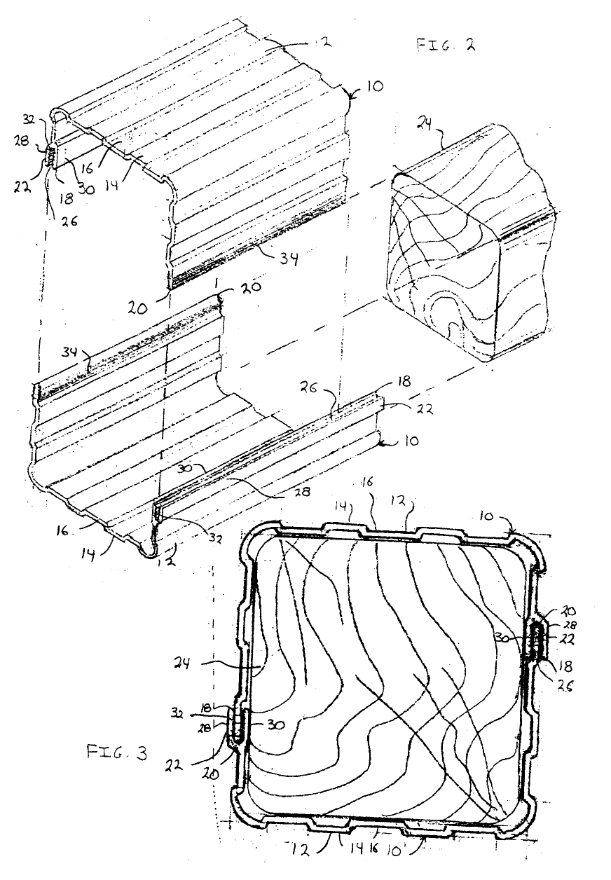

Structural element covers 10 in accordance with the present invention may be formed to have cross-sectional sizes and shapes such that a single cover 10 is adapted to cover the entire outer surface of a board or other structural element by itself, or such that two or more such cover pieces 10 are required to cover the outer surface of a board or other structural element. For example, especially for covers 10 sized to cover smaller boards (e.g., 2×2s), a single cover piece 10 in accordance with the present invention, with, e.g., a closure slot 26 and opposed edge 20 to be engaged therein formed on the piece, may be employed. Alternatively, as illustrated in FIGS. 2 and 3, two or more such pieces 10 may be used together to cover a larger board or post (e.g., a 4×4). In either case, the closure mechanism used to mount the cover piece or pieces to a structural element is, in accordance with the present invention, disguised in a manner so as not to detract from the appearance thereof.

A structural element cover 10 in accordance with the present invention may be employed as part of a method for protecting and improving the appearance of an existing wooden or other structure with exposed structural element. Either a single cover piece 10, or several cover pieces 10 which are to be joined together, are selected such that the cross-sectional size and shape of the selected piece or pieces corresponds to the outer exposed surface of the board, post, or other structural element which is to be covered. The cover piece or pieces 10 may then be cut to the appropriate length to cover the board or other structural element. Where the cover piece 10 is made of a plastic material, as is preferred, cutting of the cover piece or pieces to the appropriate length is easily accomplished by hand, using, e.g., a hacksaw. Portions of a plastic cover piece 10 in accordance with the present invention may also be cut away with a knife or scissors, as necessary, so that the piece 10 may fit around structural elements attached to the structural element to be covered, e.g., spindles attached to a deck railing to be covered. The cover piece or pieces are then positioned around the board or other structural element with the outer surface 12 of the cover 10 facing outward therefrom. Flat edges 20 extending along the length of the cover piece 10 may then be inserted into corresponding closure slots 26, to be engaged therein, thereby to secure the cover 10 to a board or other structural element. Since the closure mechanism formed by the closure channel 26 and opposing flat edge 20 is formed on the cover 10 so as to appear, e.g., substantially the same as one of many extending portions 14 formed along the length of the cover 10, the closure mechanism is effectively disguised. Therefore, a structural element cover 10 in accordance with the present invention may be employed both easily and effectively to protect and enhance the appearance of a wooden or other structure.

It should be understood that the present invention is not confined to the particular exemplary embodiments and applications illustrated and described herein, but embraces all modified forms thereof which come within the scope of the following claims.

What is claimed is:

1. A structural element cover, comprising:
(a) an elongated outer surface including alternating raised and recessed portions formed extending along a length of the cover;
(b) a first edge extending along the length of the cover; and
(c) a closure structure formed along the first edge and disguised so as to appear similar to a raised portion formed extending along a length of the outer surface.

2. The structural element cover of claim 1 wherein the closure structure is sized and shaped similarly to a raised portion extending along the length of the cover so as to appear similar to the raised portion.

3. The structural element cover of claim 1 wherein the raised portions and recessed portions are formed extending along the length of the cover in an alternating pattern and wherein the closure structure is formed along the first edge of the cover in a position thereon so as to continue the alternating pattern of raised and recessed portions.

4. The structural element cover of claim 1 wherein the closure structure includes a closure slot formed extending along the length of the first edge.

5. The structural element cover of claim 4 comprising additionally a second edge extending along a length of the cover opposite the closure slot and adapted to be received into and retained within a closure slot.

6. The structural element cover of claim 5 comprising additionally at least one locking ridge formed extending along the length of the cover near the second edge to facilitate retention of the second edge within the closure slot.

7. The structural element cover of claim 4 wherein the closure slot includes at least one locking ridge formed extending along the length of an interior thereof.

8. The structural element cover of claim 4 wherein the closure structure includes a closure structure inner wall formed extending along the length of the first edge and a closure structure outer wall formed extending along the length of the first edge with the closure slot defined between the closure structure inner wall and the closure structure outer wall.

9. The structural element cover of claim 8 wherein the closure structure outer wall is sized and shaped similarly to a raised portion extending along the length of the cover so as to appear similar to the raised portion.

10. The structural element cover of claim 1 wherein the cover is made of a plastic material.

11. The structural element cover of claim 1 wherein a cross-sectional shape of the cover is selected such that more than one structural element cover joined together is required to cover a structural element.

12. A structural element cover, comprising:
(a) an elongated outer surface including a surface characteristic extending along a length of the cover;
(b) a first edge extending along the length of the cover; and
(c) a closure structure formed along the first edge and disguised so as to blend in to the surface characteristic extending along a length of the outer surface.

13. The structural element cover of claim 12 wherein the surface characteristic extending along the length of the outer surface is an alternating pattern of raised and recessed portions formed extending along the length of the outer surface, and wherein the closure structure is sized and shaped similarly to a raised portion extending along the length of the outer surface so as to appear similar to the raised portion.

14. The structural element cover of claim 13 wherein the raised portions and recessed portions are formed extending along the length of the cover in an alternating pattern and wherein the closure structure is formed along the first edge of the cover in a position thereon so as to continue the alternating pattern of raised and recessed portions.

15. The structural element cover of claim 12 wherein the closure structure includes a closure slot formed extending along the length of the first edge.

16. The structural element cover of claim 12 wherein the cover is made of a plastic material.

17. The structural element cover of claim 12 wherein a cross-sectional shape of the cover is selected such that more than one structural element cover joined together is required to cover a structural element.

18. A method of covering a structural element, comprising the steps of:
(a) selecting a structural element cover including an elongated outer surface including alternating raised and recessed portions formed extending along a length of the cover, a first edge extending along the length of the cover, and a closure structure formed along the first edge and disguised so as to appear similar to a raised portion formed extending along a length of the outer surface;
(b) positioning the structural element cover around an outer surface of a structural element; and
(c) engaging the closure structure to secure the structural element cover to the structural element such that the closure structure is disguised so as to appear similar to a raised portion formed extending along a length of the outer surface of the cover.

19. The method of claim 18 wherein the structural element cover closure structure includes a closure slot formed extending along the length of the first edge, and wherein the step of engaging the closure structure includes the step of inserting a flat edge of a structural element cover into the closure slot to be retained therein.

20. The method of claim 19 wherein the selected structural element cover is sized and shaped to cover a portion of the structural element and wherein the flat edge of the structural element cover inserted into the closure groove is a second edge formed on a second complementary structural element cover including an elongated outer surface including alternating raised and recessed portions formed extending along a length of the cover, a first edge extending along the length of the cover, and a closure structure formed along the first edge and disguised so as to appear similar to a raised portion formed extending along a length of the outer surface.

21. The method of claim 18 comprising additionally the step of cutting the selected structural element cover to a selected length before positioning the structural element cover around the outer surface of the structural element.
